(19) United States
(12) Patent Application Publication
(10) Pub. No.: US 2025/0299691 A1
(43) Pub. Date: Sep. 25, 2025

(54) MAGNETIC DISK DEVICE

(71) Applicants: Kabushiki Kaisha Toshiba, Tokyo (JP); Toshiba Electronic Devices & Storage Corporation, Tokyo (JP)

(72) Inventor: Toru WATANABE, Kawasaki Kanagawa (JP)

(21) Appl. No.: 18/753,550

(22) Filed: Jun. 25, 2024

(30) Foreign Application Priority Data
Mar. 19, 2024 (JP) 2024-043554

(51) Int. Cl. G11B 5/40; G11B 5/012; G11B 27/36

(52) U.S. Cl. CPC G11B 5/40; G11B 5/012; G11B 27/36

(57) ABSTRACT

According to one embodiment, a magnetic disk device includes a rotatable recording medium including concentric recording tracks, a magnetic head including a recording element having a first width, a reproducing element having a second width, and a thermal resistance sensor having a third width wider than the first width and the second width, a head actuator that positions the magnetic head on any recording track, a detection circuit that detects defects on a surface of the recording medium based on a sensor output of the thermal resistance sensor, and a controller that, when inspecting the surface condition of the recording medium by the thermal resistance sensor, sets a feed pitch of the magnetic head to within ½ of the third width and three or more recording tracks.

### CROSS-REFERENCE TO RELATED APPLICATIONS

This application is based upon and claims the benefit of priority from Japanese Patent Application No. 2024-043554, filed Mar. 19, 2024, the entire contents of which are incorporated herein by reference.

### FIELD

Embodiments described herein relate generally to a magnetic disk device.

### BACKGROUND

A disk device, for example, a magnetic disk device, comprises a rotatable disk-shaped recording medium having a magnetic recording layer, and a magnetic head that records and reproduces data on the magnetic recording layer of the recording medium. The magnetic head includes a slider and a read head and a write head provided on the slider. In such magnetic disk devices, it is necessary to reduce a gap between the magnetic head and the recording medium in order to improve recording density, especially linear recording density. Since the magnetic head records and reproduces information by moving relative to a recording surface of the recording medium with a minute gap as small as 1 nm, the recording surface of the recording medium is required to be smooth.

However, the recording surface of the recording medium has defects that occur during the manufacturing process of the recording medium, such as microscopic projections with a height of about 3 to 8 nm. When the magnetic head runs on the recording surface with a minute gap, the magnetic head collides with the microscopic projections. Repeated collisions with the microscopic projections can damage the magnetic head, making it difficult to perform recording and reproduction.

### BRIEF DESCRIPTION OF THE DRAWINGS

FIG. 1 is a block diagram schematically showing a hard disk drive (HDD) according to a first embodiment.

FIG. 2 is a side view schematically showing a magnetic head, a suspension, and a magnetic disk in the HDD.

FIG. 3 is a cross-sectional view showing an enlarged head portion of the magnetic head.

FIG. 4 is a plan view of the head portion of the magnetic head from an ABS side.

FIG. 5 is a side view schematically showing a magnetic head and the head portion in a state where a recording head portion is expanded by a thermal actuator.

FIG. 6 is a circuit diagram of an inspection circuit of the HDD.

FIG. 7 schematically shows an output of a thermal resistance sensor when in contact with a projection on a recording medium.

FIG. 8 schematically shows an output of a thermal resistance sensor when passing through a recess on a recording medium.

FIG. 9 schematically shows a relationship between a thermal resistance sensor, a recording track, and a projection.

FIG. 10 schematically shows a positional relationship between a recording track, a reproducing and recording element, and a thermal resistance sensor during recording.

FIG. 11 schematically shows a positional relationship between a recording track, a reproducing and recording element, and a thermal resistance sensor during reproduction.

FIG. 12 shows a relationship between a radial position of a magnetic head and a yaw angle.

FIG. 13 schematically shows an operation of setting a record-prohibited track.

FIG. 14A shows a positional relationship between a width of a thermal resistance sensor (when wide) and an element part.

FIG. 14B shows a positional relationship between a width of a thermal resistance sensor (when narrow) and an element part.

FIG. 15 shows a peak value transition of a thermal resistance sensor during projection detection.

FIG. 16 is a plan view schematically showing a detection operation 1 for detecting surface defects (projections or recesses) and a setting operation for a record-prohibited track or a record-prohibited sector.

FIG. 17 is a plan view schematically showing a detection operation 2 for detecting surface defects (projections or recesses) and a setting operation for a record-prohibited track or a record-prohibited sector.

FIG. 18 is a plan view schematically showing a detection operation 3 for detecting surface defects (projections or recesses) and a setting operation for a record-prohibited track or a record-prohibited sector.

FIG. 19 is a plan view schematically showing a detection operation 1 for detecting surface defects (projections or recesses) and a setting operation for a record-prohibited track or a record-prohibited sector in an HDD according to a second embodiment.

FIG. 20 is a plan view schematically showing a detection operation 2 for detecting surface defects (projections or recesses) and a setting operation for a record-prohibited track or a record-prohibited sector in an HDD according to the second embodiment.

FIG. 21 is a plan view schematically showing a detection operation 3 for detecting surface defects (projections or recesses) and a setting operation for a record-prohibited track or a record-prohibited sector in an HDD according to the second embodiment.

FIG. 22A shows a positional relationship between a width of a thermal resistance sensor and an element part of a magnetic head according to a first modification.

FIG. 22B shows a positional relationship between a width of a thermal resistance sensor and an element part of a magnetic head according to a second modification.

FIG. 23A shows a positional relationship between a width of a thermal resistance sensor and an element part of a magnetic head according to a third modification.

FIG. 23B shows a positional relationship between a width of a thermal resistance sensor and an element part of a magnetic head according to a fourth modification.

### DETAILED DESCRIPTION

Various embodiments will be described hereinafter with reference to the accompanying drawings. In general, according to one embodiment, a magnetic disk device comprises a rotatable disk-shaped recording medium including a plurality of concentric recording tracks; a magnetic head comprising a recording element having a first width in a direction intersecting the recording tracks, a reproducing element having a second width in a direction intersecting the recording tracks, and a thermal resistance sensor having a third width in a direction intersecting the recording tracks, which is wider than the first width and the second width, and detecting a surface condition of the recording medium; a head actuator that positions the magnetic head on any recording track of the recording medium; a detection circuit that detects defects on a surface of the recording medium based on a sensor output of the thermal resistance sensor; and a controller that, when inspecting the surface condition of the recording medium by the thermal resistance sensor, sets a feed pitch of the magnetic head in a width direction of the recording track to within ½ of the third width of the thermal resistance sensor and three or more recording tracks.

Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. Further, in the specification and drawings, corresponding elements are denoted by like reference numerals, and a detailed description thereof may be omitted unless otherwise necessary.

### First Embodiment

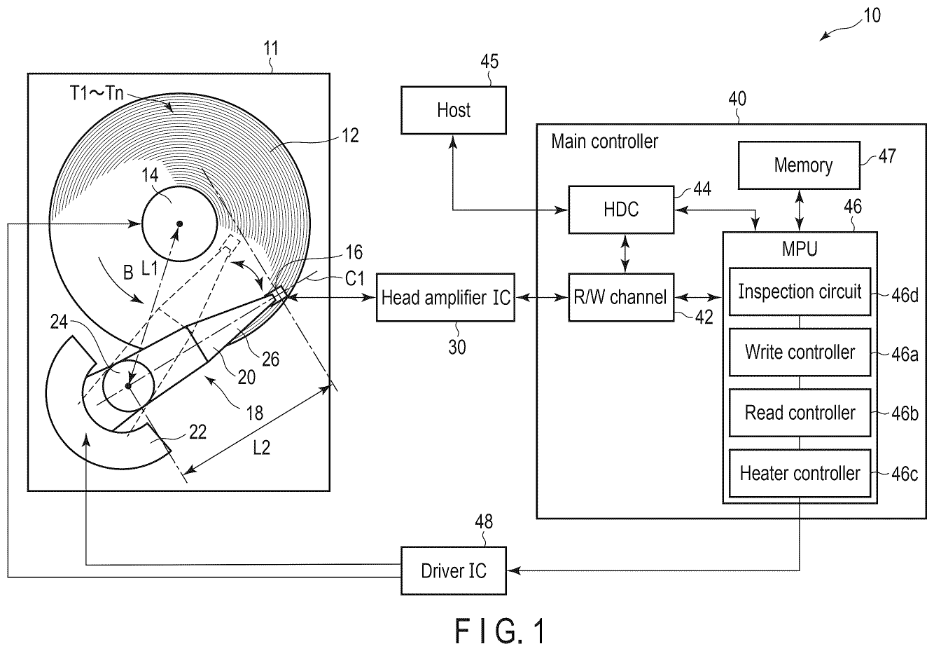

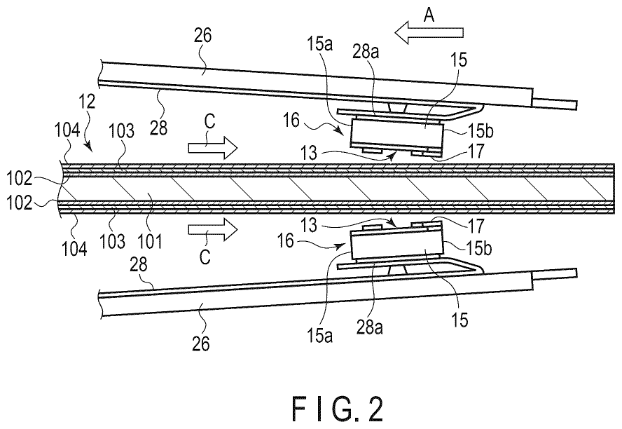

As an example of a magnetic disk device, a hard disk drive (HDD) according to a first embodiment will be described in detail. FIG. 1 is a block diagram schematically showing the HDD according to the first embodiment, and FIG. 2 is a side view showing a magnetic head in a flying state and a magnetic disk.

As shown in FIG. 1, an HDD 10 comprises a rectangular-shaped housing 11, a magnetic disk 12 as a recording medium located in the housing 11, a spindle motor 14 that supports and rotates the magnetic disk 12, and a plurality of magnetic heads 16 that record (write) and reproduce (read) data with respect to the magnetic disk 12. The HDD 10 comprises a head actuator 18 that moves and positions the magnetic heads 16 on any track on the magnetic disk 12. The head actuator 18 includes a carriage assembly 20 that movably supports the magnetic heads 16 and a voice coil motor (VCM) 22 that rotates the carriage assembly 20.

The HDD 10 comprises a controller including a head amplifier IC 30 that drives the magnetic heads 16, a main controller 40, and a driver IC 48. The head amplifier IC 30 is provided, for example, in the carriage assembly 20 and is electrically connected to the magnetic heads 16. The head amplifier IC 30 includes a recording current supply circuit (recording current supply unit) that supplies a recording current to a recording coil of the magnetic heads 16, a heater power supply circuit that supplies drive power to a thermal actuator (heater) of the magnetic heads 16 as described later, an amplifier that amplifies a signal read by the magnetic heads 16, etc.

The main controller 40 and the driver IC 48 are configured, for example, on a control circuit board, not shown, provided on a back side of the housing 11. The main controller 40 comprises an R/W channel 42, a hard disk controller (HDC) 44, a microprocessor (MPU) 46, a memory 47, and the like. The main controller 40 is electrically connected to the magnetic heads 16 via the head amplifier IC 30. The main controller 40 is electrically connected to the VCM 22 and the spindle motor 14 via the driver IC 48. The HDC 44 is connectable to a host computer 45.

In the main controller 40, for example, the MPU 46 includes a write controller 46a that controls a write head, a read controller 46b that controls a read head, a heater controller 46c that controls power supplied to a thermal actuator, and an inspection circuit 46d. The inspection circuit 46d inspects for defects on the surface of the magnetic disk 12, as described below. The memory 47 stores various data such as inspection results, record-prohibited tracks, record-prohibited sectors, heater power setting values.

As shown in FIG. 1 and FIG. 2, the magnetic disk 12 is configured as a perpendicular magnetic recording medium. The magnetic disk 12 has a substrate 101 made of a non-magnetic material formed in a disk shape with a diameter of, for example, 96 mm (about 3.5 inches). On each surface of the substrate 101, a soft magnetic layer 102 made of a material exhibiting soft magnetic properties as a base layer, a perpendicular magnetic recording layer 103 having magnetic anisotropy perpendicular to the surface of the magnetic disk 12, and a protective film 104, as upper layers thereof, are sequentially layered. The magnetic disk 12 is coaxially fitted together to a hub of the spindle motor 14. The magnetic disk 12 is rotated by the spindle motor 14 in the direction of arrow B at a predetermined speed.

As shown in FIG. 1, a number of concentric recording tracks T1 to Tn are formed on each surface (magnetic recording layer) of the magnetic disk 12. Each recording track includes a plurality of sectors aligned in a circumferential direction.

The carriage assembly 20 includes a bearing portion 24 rotatably supported by the housing 11 and a plurality of arms and suspensions 26 extending from the bearing portion 24. As shown in FIG. 2, the magnetic heads 16 are supported on an extending end of each suspension 26. The magnetic heads 16 are electrically connected to the head amplifier IC 30 via a wiring member (flexure) 28 provided on the carriage assembly 20.

As shown in FIG. 2, the magnetic heads 16 are configured as flying heads and include a slider 15 formed in an approximately rectangular shape and a head portion 17 formed at an end portion on an outflow (trailing) end side of the slider 15. The slider 15 is formed of, for example, a sintered body of alumina and titanium carbide (Altic), and the head portion 17 is formed by a plurality of layers of thin film. The slider 15 is attached to a gimbal portion 28a of the wiring member 28.

The slider 15 includes an approximately rectangular disk-facing surface (air bearing surface (ABS)) 13 facing the surface of the surface of the magnetic disk 12. The slider 15 is maintained in a state of flying a predetermined amount from the surface of the magnetic disk 12 by an airflow C generated between the disk surface and the ABS 13 by the rotation of the magnetic disk 12. The direction of the airflow C coincides with a rotation direction B of the magnetic disk 12. The slider 15 includes a leading end 15a located on an inflow side of the airflow C and a trailing end 15b located on an outflow side of the airflow C. As the magnetic disk 12 rotates, the magnetic heads 16 run in the direction of arrow A (head running direction) with respect to the magnetic disk 12, i.e., in a direction opposite to the disk rotation direction B.

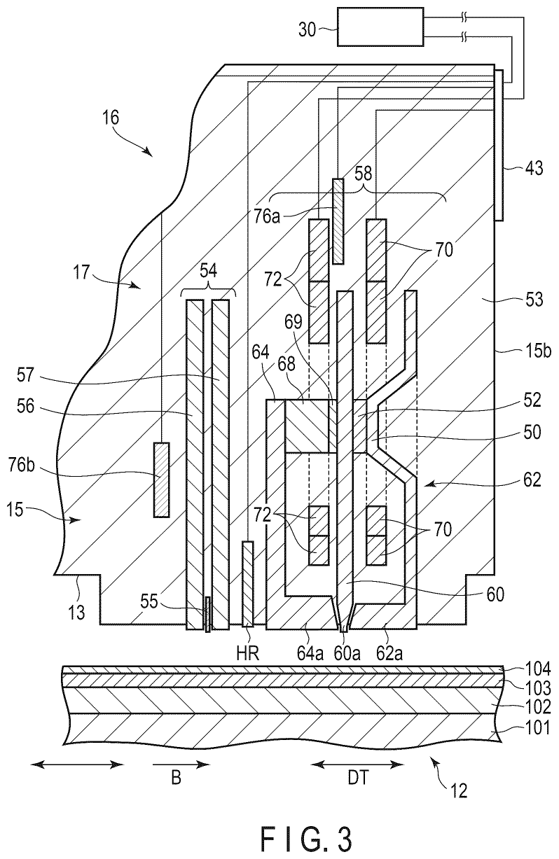

FIG. 3 is a cross-sectional view of the head portion 17 of the magnetic head 16 and the magnetic disk 12 in an enlarged view.

As shown in FIG. 3, the head portion 17 includes a read head (sometimes referred to as a reproducing element) 54 and a write head (sometimes referred to as a recording element) 58 formed by a thin film process on the trailing end 15b of the slider 15, and is formed as a separate magnetic head. The read head 54 and write head 58 are covered by a non-magnetic protective insulating film 53, except for the portion of the slider 15 exposed to the ABS 13. The protective insulating film 53 configures the outline of the head portion 17. Furthermore, the head portion 17 includes a thermal resistance sensor HR that detects the surface condition (defect state) of the magnetic disk surface, a first thermal actuator that controls the protrusion amount of the write head 58, and a second thermal actuator that controls the protrusion amount of the read head 54. Note that it is defined that the surface condition of a magnetic disk refers to the presence or absence of defects (projections or recesses) on the surface of the magnetic disk, i.e., whether or not there are defects (projections or recesses) on the disk surface, as described below.

The longitudinal direction (circumferential direction) of a recording track formed on the perpendicular magnetic recording layer 103 of the magnetic disk 12 is defined as a track circumferential direction DT, and the width direction of the recording track orthogonal to the longitudinal direction is defined as a cross track direction WT.

The read head 54 includes a magnetoresistive element 55, a first magnetic shield film 56, and a second magnetic shield film 57. The first magnetic shield film 56 and the second magnetic shield film 57 are arranged to sandwich the magnetoresistive element 55 on the leading side (inflow side) and the trailing side (outflow side) of the magnetoresistive element 55 in the track circumferential direction DT. The magnetoresistive element 55, and the first and second magnetic shield films 56 and 57 extend approximately perpendicular to the ABS 13. Bottom end portions (distal end portions) of the magnetoresistive element 55 and the first and second magnetic shield films 56 and 57 protrude slightly from the ABS 13.

The write head 58 is provided on the trailing end 15b side of the slider 15 with respect to the read head 54. The write head 58 includes a main magnetic pole 60 that generates a recording magnetic field perpendicular to the surface of the magnetic disk 12, a trailing shield 62 provided on the trailing side of the main magnetic pole 60 and facing the main magnetic pole 60 with a write gap, a leading shield 64 facing the leading side of the main magnetic pole 60, and a pair of side shields, not shown, formed as a single piece with the trailing shield 62. The main magnetic pole 60 and the trailing shield 62 constitute a first magnetic core forming a magnetic path, and the main magnetic pole 60 and the leading shield 64 constitute a second magnetic core forming a magnetic path. The write head 58 includes a first recording coil 70 wound around the first magnetic core and a second recording coil 72 wound around the second magnetic core.

The main magnetic pole 60 is formed from a soft magnetic material having high permeability and high saturation magnetic flux density and extends approximately perpendicular to the ABS 13. A distal end portion 60a of the main magnetic pole 60 on the ABS 13 side is tapered toward the ABS 13 to form a columnar shape that is narrower than the other portions. The distal end portion 60a of the main magnetic pole 60 protrudes slightly from the ABS 13 of the slider 15.

The trailing shield 62 is formed of a soft magnetic material and is provided to efficiently close the magnetic path through the soft magnetic layer 102 of the magnetic disk 12 directly below the main magnetic pole 60. The trailing shield 62 is formed approximately in an L-shape, with its distal end portion 62a formed in an elongated rectangular shape. The distal end portion 62a of the trailing shield 62 protrudes slightly from the ABS 13 of the slider 15.

The trailing shield 62 includes a first connecting portion 50 connected to the main magnetic pole 60. The first connecting portion 50 is magnetically connected to an upper part of the main magnetic pole 60, i.e., a portion of the main magnetic pole 60 away from the ABS 13, via a non-conductor 52. The first recording coil 70 is wound around the first connecting portion 50, for example, in the first magnetic core. When writing signals to the magnetic disk 12, by applying a recording current to the first recording coil 70, the first recording coil 70 excites the main magnetic pole 60 and causes a magnetic flux to flow to the main magnetic pole 60.

The leading shield 64 formed of a soft magnetic material is provided on the leading side of the main magnetic pole 60 facing the main magnetic pole 60. The leading shield 64 is formed in an approximately L-shape, and a distal end portion 64a on the ABS 13 side is formed in an elongated rectangular shape. The distal end portion 64a protrudes slightly from the ABS 13 of the slider 15.

The leading shield 64 also includes a second connecting portion 68 joined to the main magnetic pole 60 at a distance from the ABS 13. This second connecting portion 68 is formed, for example, of a soft magnetic material and is magnetically connected to an upper part of the main magnetic pole 60, i.e., a portion of the main magnetic pole 60 away from the ABS 13, via a non-conductor 69. As a result, the second connecting portion 68 forms a magnetic circuit together with the main magnetic pole 60 and the leading shield 64. The second recording coil 72 of the write head 58 is wound around the second connecting portion 68, for example, and applies a magnetic field to this magnetic circuit.

The first thermal actuator includes, for example, a heater 76a. The heater 76a is embedded within the protective insulating film 53 and is located near the write head 58. The second thermal actuator includes, for example, a heater 76b. The heater 76b is embedded within the protective insulating film 53 and located near the read head 54.

The thermal resistance sensor HR is embedded within the protective insulating film 53 and is located between the write head 58 and the read head 54. A sensing end (distal end portion) of the thermal resistance sensor HR is exposed to or protrudes slightly from the ABS 13.

As shown in FIG. 3, a plurality of connection terminals 43 are provided at the trailing end 15b of the slider 15. The first recording coil 70 and the second recording coil 72 are each connected to the connection terminals 43 via wiring and are further connected to the head amplifier IC 30 via the flexure 28. When writing signals to the magnetic disk 12, a recording current is supplied to the first recording coil 70 and the second recording coil 72 from the recording current supply circuit of the head amplifier IC 30 to excite the main magnetic pole 60 and cause magnetic flux to flow to the main magnetic pole 60. The recording current supplied to the first recording coil 70 and the second recording coil 72 is controlled by the main controller 40.

The magnetoresistive element 55 of the read head 54 is connected to the connection terminals 43 via wiring, not shown, and is further connected to the head amplifier IC 30 via the flexure 28. The signals read by the read head 54 are amplified by the head amplifier IC 30 and transmitted to the main controller 40.

The first heater 76a and the second heater 76b are each connected to the connection terminals 43 via wiring and further connected to the head amplifier IC 30 via the flexure 28. By applying drive power to the first heater 76a and second heater 76b from the heater power supply circuit of the head amplifier IC 30, the heaters and the surroundings of the heaters can be heated to cause the write head 58 or the read head 54 to expand toward the magnetic disk 12 side. Heater power supplied to the first and second heaters 76a and 76b is controlled by the heater controller 46c of the main controller 40.

The thermal resistance sensor HR is connected to the connection terminals 43 via wiring and further connected to the head amplifier IC 30 via the flexure 28. Detection signals (sensor output) of the thermal resistance sensor HR are transmitted to the inspection circuit 46d of the main controller 40 via the head amplifier IC 30.

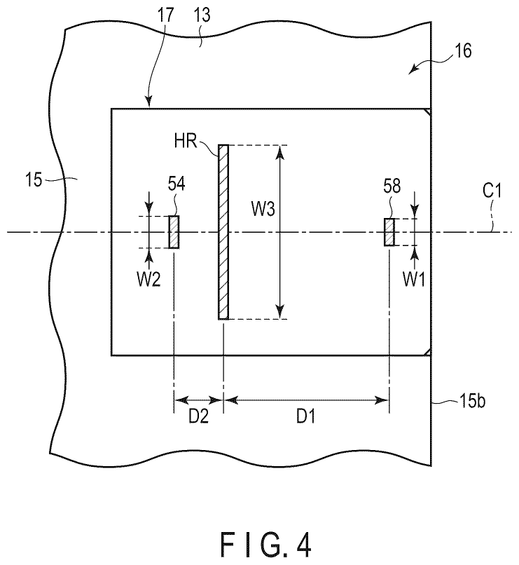

FIG. 4 is a plan view of the head portion 17 of the magnetic head 16 observed from the ABS side. As shown in the drawing, the write head 58, the thermal resistance sensor HR, and the read head 54 are sequentially aligned along a central axis C1 in the longitudinal direction (track circumferential direction DT) of the magnetic head 16. The distal end portion of the write head 58 (main magnetic pole distal end portion) exposed to the ABS 13 has a first width W1 in a direction orthogonal to the central axis C1. The distal end portion of the read head 54 exposed to the ABS 13 has a second width W2 in a direction orthogonal to the central axis C1. The distal end portion (sensing end) of the thermal resistance sensor HR exposed to ABS 13 has a third width W3 in a direction orthogonal to the central axis C1. The third width W3 is larger than the first width W1 and larger than the second width W2.

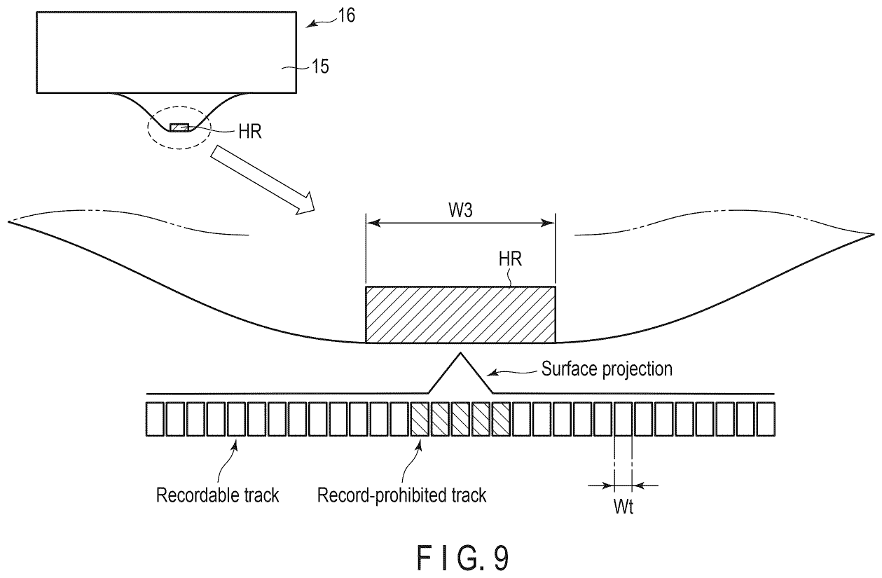

A track width Wt (see FIG. 9) of the recording track formed on the magnetic disk 12 substantially matches the width W1 of the write head 58. Strictly speaking, the track width Wt matches the width of the recording magnetic field generated from the write head 58. The width W3 of the thermal resistance sensor HR is set sufficiently wider than the first width W1, e.g., several tens of times wider than the width W1. In one example, when the track width Wt is 0.05 μm, the width W3 of the thermal resistance sensor is set to approximately 20 times the width W1.

The distal end portion of the write head 58, the distal end portion of the read head 54, and the distal end portion of the thermal resistance sensor HR each extend in a direction orthogonal to the central axis C1. In the present embodiment, in the ABS 13, the distal end portion of the write head 58, the distal end portion of the read head 54, and the distal end portion of the thermal resistance sensor HR each have the widthwise centers thereof located on the central axis C1, and are each symmetrically arranged with respect to the central axis C1.

In the ABS 13, the distal end portion of the thermal resistance sensor HR is located between the distal end portion of the write head 58 and the distal end portion of the lead head 54. In the present embodiment, a spacing D1 between the write head 58 and the thermal resistance sensor HR and a spacing D2 between the read head 54 and the thermal resistance sensor HR in a direction parallel to the central axis C1 are set to D1>D2. Note that the spacings D1 and D2 are not limited to the embodiment, and can be changed in various ways.

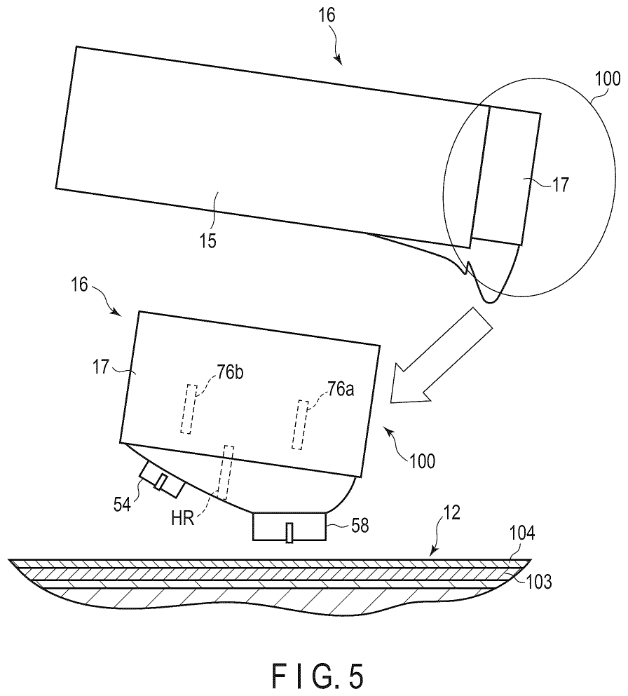

FIG. 5 is a schematic side view of the magnetic head and the head portion in a state where the recording head portion is ejected by the thermal actuator. As shown in the drawing, for example, by applying drive power to the first heater 76a, the first heater 76a and its surroundings are heated, and the write head 58 portion is expanded toward the magnetic disk 12 side. This allows a gap between the write head 58 and the surface of the magnetic disk 12 (flying height of head) to be adjusted.

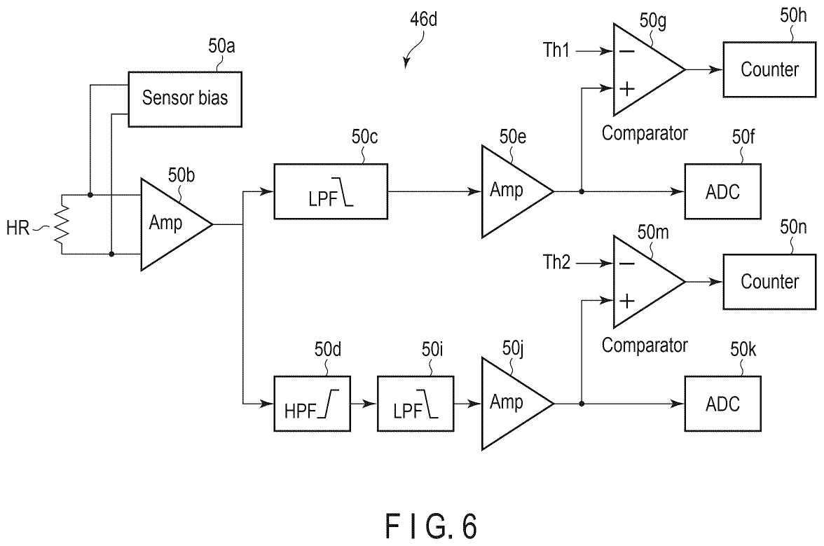

FIG. 6 is a circuit diagram showing an example of an inspection circuit. The inspection circuit 46d is provided with, for example, a dedicated frequency filter according to the size of the defect to be detected, and determines the presence or absence of the defect by whether it exceeds a preset threshold value. As shown in FIG. 6, in one example, the inspection circuit 46d includes a sensor bias 50a that applies a bias voltage to the thermal resistance sensor HR, an amplifier (Amp) 50b that amplifies a detection signal of the thermal resistance sensor HR, a low-pass filter (LPF) 50c, and a high-pass filter 50d. The sensor bias 50a and the amplifier 50b may be configured within the head amplifier IC 30.

The inspection circuit 46d includes an amplifier (Amp) 50e that amplifies an output signal of the low-pass filter 50c, an AD converter (ADC) 50f, a comparator 50g that compares the output signal of the amplifier 50e with a wide defect threshold value Th1, and a counter 50h that counts the output signal of the comparator 50g. Furthermore, the inspection circuit 46d includes a low-pass filter (LPF) 50i following the high-pass filter 50d, an amplifier (Amp) 50j, an AD converter (ADC) 50k, a comparator 50m that compares an output signal of the amplifier 50j with a narrow defect threshold value Th2, and a counter 50n that counts the output signal of the comparator 50m.

Next, in the HDD 10 configured as described above, an operation of detecting a defect (projections or recesses) on the surface of the magnetic disk 12 and an operation of setting a write-prohibited track or a write-prohibited sector will be described. The HDD 10 executes defect detection and setting of the record-prohibited track at the time of shipment, at a certain period of time, or at each recording operation.

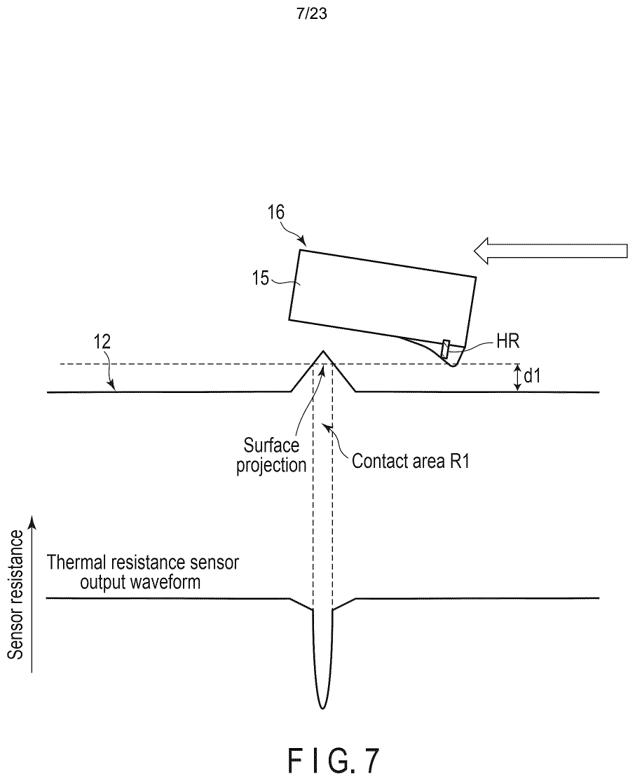

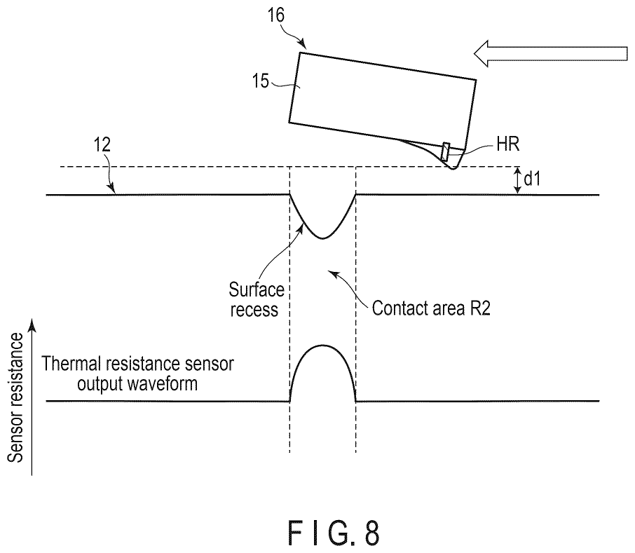

FIG. 7 schematically shows the output of the thermal resistance sensor when contacting a projection on the recording medium, and FIG. 8 schematically shows the output of the thermal resistance sensor when passing through a recess on the recording medium.

As shown in FIG. 7, in a case where a projection higher than a flying height d1 of the thermal resistance sensor HR occurs on the surface of the magnetic disk 12, the thermal resistance sensor HR may collide with the projection when passing over the projection, which may cause the resistance value of the thermal resistance sensor HR to change, i.e., the resistance value to decrease. Therefore, the output waveform of the thermal resistance sensor HR becomes a waveform in which a portion corresponding to a contact area R1 is lowered.

As shown in FIG. 8, in a case where the surface of magnetic disk 12 is recessed, the resistance value of the thermal resistance sensor HR rises when thermal resistance sensor HR passes over the recess. Therefore, the output waveform of the thermal resistance sensor HR becomes a waveform in which a portion corresponding to a passing area R2 above the recess is raised.

Therefore, by observing and analyzing the output waveform of the thermal resistance sensor HR while running the magnetic head 16 along each track of the magnetic disk 12, it is possible to detect the presence or absence of projections or recesses on the surface of the magnetic disk 12 and to determine whether they are projections or recesses. That is, the inspection circuit 46d of the main controller 40 processes the output signal (output waveform) transmitted from the thermal resistance sensor HR to detect the presence or absence of projections and recesses on the surface of the magnetic disk 12, to determine whether they are projections or recesses, and to detect the position of the projections and recesses.

FIG. 9 schematically shows a relationship between the thermal resistance sensor HR, the recording track, and projections. In a case where a projection is determined, the main controller 40 sets a track on which the projection is present as a record-prohibited track as shown in FIG. 9. After the setting, the main controller 40 prohibits recording operations on the record-prohibited track, i.e., the magnetic head 16 is prohibited from accessing over the record-prohibited track. This prevents the magnetic head 16 from colliding with projections on the disk surface after the record-prohibited track is set.

On the other hand, to increase the recording density of the magnetic disk device, it is necessary to increase the number of recording tracks formed on the recording medium, which means that the track width Wt of one recording track becomes narrower. In this case, the number of record-prohibited tracks will increase if projections of the same size are present on the recording medium. In addition, if the number of recording tracks increases, more time will be required to inspect all recording tracks. Therefore, the HDD according to the present embodiment is configured to shorten the time required to inspect the magnetic disk 12 for defects.

As shown in FIG. 9, the width W3 of the thermal resistance sensor HR mounted on the magnetic head 16 is set to a width spanning a plurality of recording tracks, for example, 1 μm. On the other hand, the track width Wt of the recording track on the magnetic disk 12 is, for example, 0.05 μm, and is set so that a plurality of recording tracks are present under the thermal resistance sensor HR.

As shown in FIG. 1 and FIG. 4, the thermal resistance sensor HR, the recording head 58, and the read head 54 of the magnetic head 16 are arranged side by side on the central axis C1 passing through the center of the bearing portion 24 of the carriage assembly 20 and the center of the magnetic head 16.

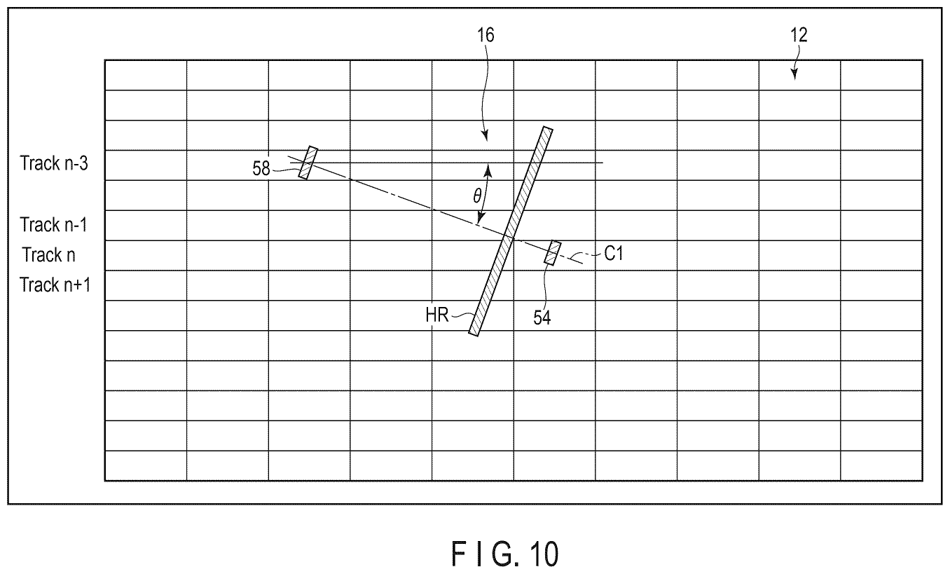

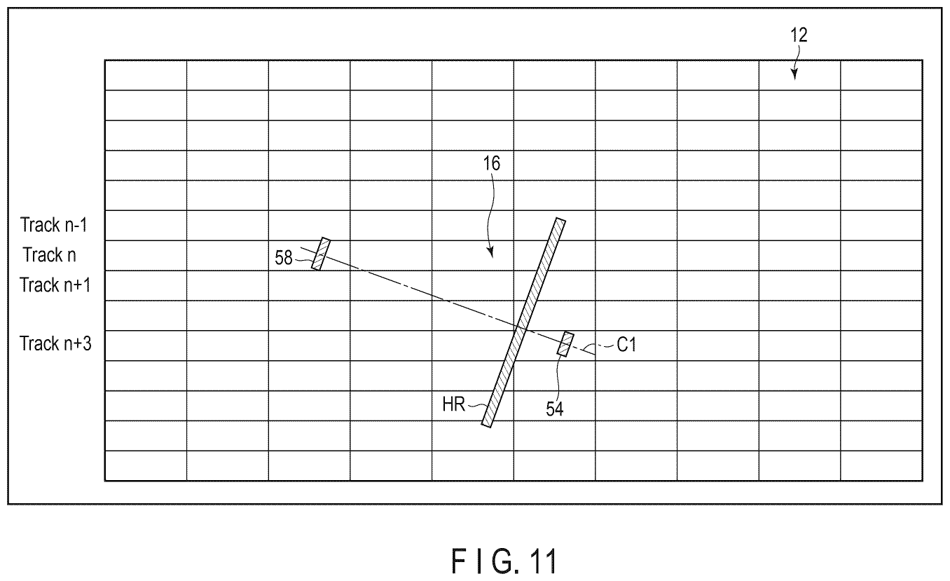

FIG. 10 schematically shows a positional relationship between a recording track and a reproducing and recording element, and the thermal resistance sensor during recording. FIG. 11 schematically shows a positional relationship between a recording track, and a reproducing and recording element, and the thermal resistance sensor during reproduction.

FIG. 10 shows a positional relationship between the read head 54, the thermal resistance sensor HR, and the write head 58 in the HDD 10 when the carriage assembly 20 is rotated by the VCM 22, and, for example, the magnetic heads 16 are moved near the outer circumference of the magnetic disk 12. In the drawing, an angle θ formed by the recording track and the central axis C1 of the head portion 17 indicates a yaw angle. The read head 54 is positioned on recording track n, and the write head 58 is located on recording track n−3. When setting the record-prohibited track, it is necessary to consider the positional relationship between the write head and read head.

FIG. 11 shows the magnetic heads 16 positioned in a different radial position than in FIG. 10. As shown in the drawing, the write head 58 is positioned on the same recording track n; however, the read head 54 is located on recording track n+3.

By grasping in advance and storing in the memory 47 the positional relationship of the write head 58, the read head 54, and the thermal resistance sensor HR corresponding to the radial position of the magnetic head 16, an approximate positional relationship between the write head 58 and read head 54 and the projection detection position can be known. It is possible to set the record-prohibited track reflecting the above positional relationship.

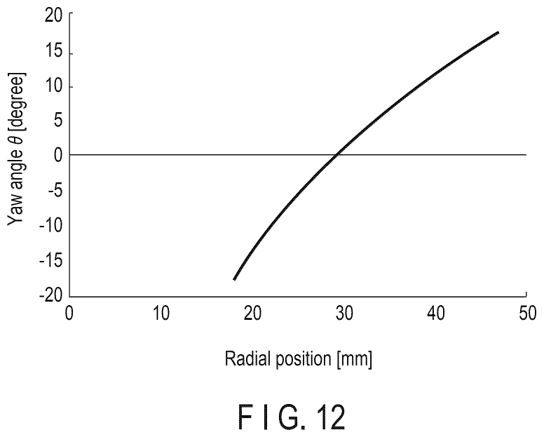

It is also necessary to grasp the yaw angle θ corresponding to the radial position of the magnetic heads 16. As shown in FIG. 1, the yaw angle θ can be uniquely determined from a distance L1 between the center of the bearing portion 24 and the center of the spindle motor, a distance L2 between the center of the bearing portion 24 and the magnetic head 16s, and the radial position of the magnetic heads 16 on the magnetic disk 12. FIG. 12 shows an example of calculating the yaw angle θ corresponding to the radial position of the magnetic head.

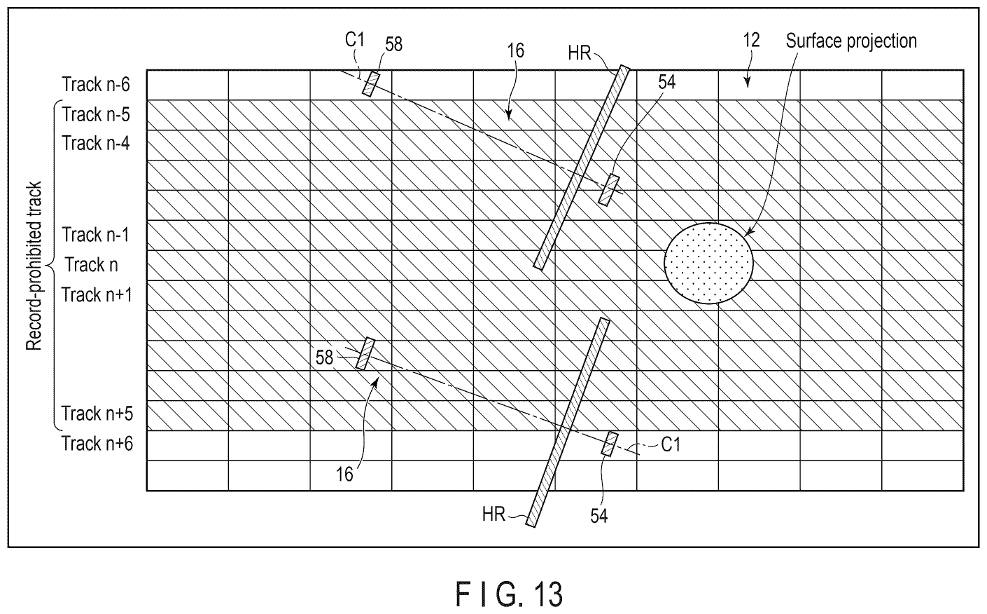

FIG. 13 is a plan view of an example of setting an ideal record-prohibited track. In the drawing, the shaded tracks correspond to the record-prohibited tracks.

As shown in FIG. 13, in a case where a surface projection is present over three recording tracks n−1, n, and n+1, recording tracks n−5 to n+5, including four tracks on the outer circumference and four tracks on the inner circumference, are set as record-prohibited tracks. This prevents, for example, the write head 58 and the read head 54 from contacting the surface projection even in a case where the write head 58 is positioned on recording track n−6. Also, even in a case where the read head 54 is positioned on recording track n+6, the write head 58 will not contact the surface projection.

However, since there is a limit to accurately measuring the size of the surface projection on a track-by-track basis, it is desirable to set a record-prohibited track with a margin of one to two tracks.

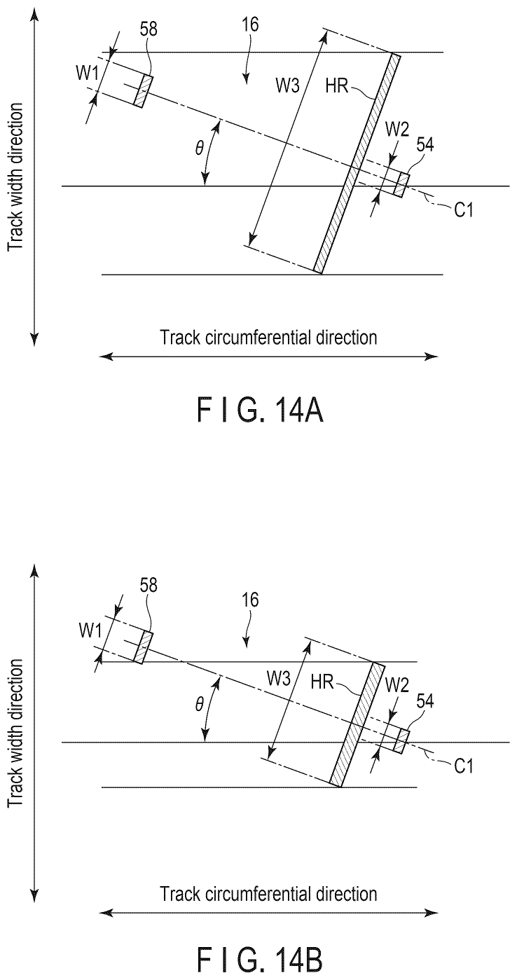

FIG. 14A shows a positional relationship between the width of the thermal resistance sensor (when wide) and the element part, and FIG. 14B shows a positional relationship between the width of the thermal resistance sensor (when narrow) and the element part.

As shown in the drawings, when the yaw angle θ becomes large (maximum yaw angle), depending on the width W3 of the thermal resistance sensor HR, the write head 58 and the read head 54 may fall outside the range of the width W3 of the thermal resistance sensor HR. As shown in FIG. 14A, in a case where the width W3 of the thermal resistance sensor HR is wide, the write head 58 and the read head 54 are within the width W3 of the thermal resistance sensor HR in the track circumferential direction. As shown in FIG. 14B, in a case where the width W3 of the thermal resistance sensor HR is narrow, the write head 58 falls outside the range of the width W3 of the thermal resistance sensor HR in the track circumferential direction. Therefore, it is also desirable to grasp where the write head 58 and the read head 54 are in relation to the recording track detected by the thermal resistance sensor HR.

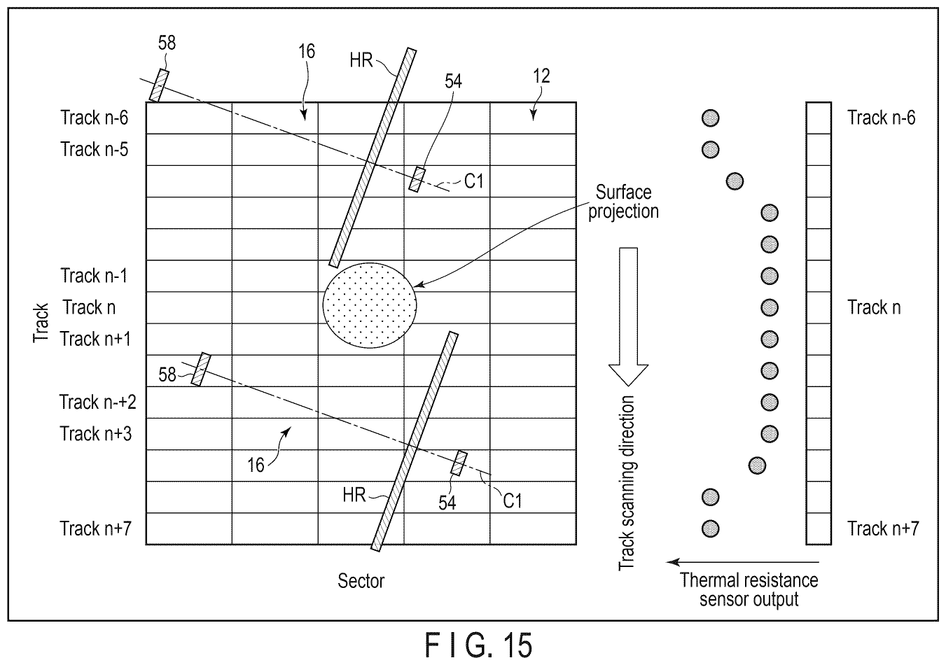

FIG. 15 schematically shows a positional relationship between the surface projection and the magnetic head, and a relationship between the surface projection and a sensor output of the thermal resistance sensor.

As shown in the drawing, in a case where defect detection is performed by the thermal resistance sensor HR for all recording tracks, for example, in a case where the surface projection is on recording tracks n−1, n, and n+1, the sensor output of the thermal resistance sensor HR at each recording track detection is as shown on the right. That is, when the thermal resistance sensor HR passes over and near the surface projection, the resistance of the thermal resistance sensor HR increases and the sensor output decreases. The number of recording tracks where the center of the surface projection is present and the number of recording tracks detected by the thermal resistance sensor HR are the width W3 of the thermal resistance sensor HR plus the width of the surface projection. In the example shown in the drawing, the center of the defect detection position is shifted by an amount that takes into account the yaw angle θ in addition to the distance between the read head 54 and the thermal resistance sensor HR. It is possible to accurately estimate such geometric error. Since the number of contacts between the write head 58 and read head 54 and the surface projection may increase, it is desirable to set the record-prohibited track with a margin of one to two tracks, as mentioned above.

In the HDD according to the present embodiment, the detection of surface defects and the setting of record-prohibited tracks or record-prohibited sectors are executed in consideration of the above points.

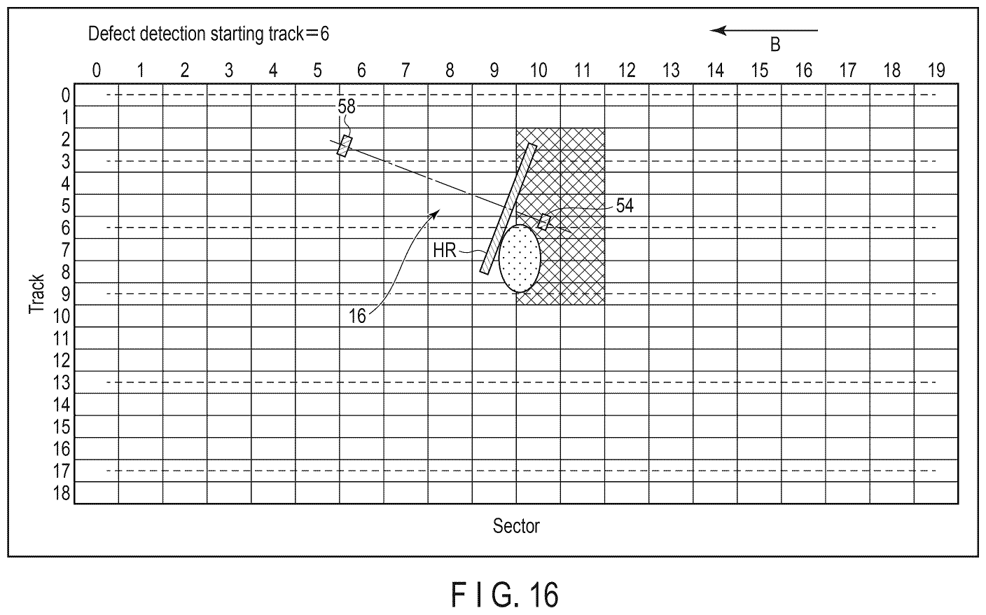

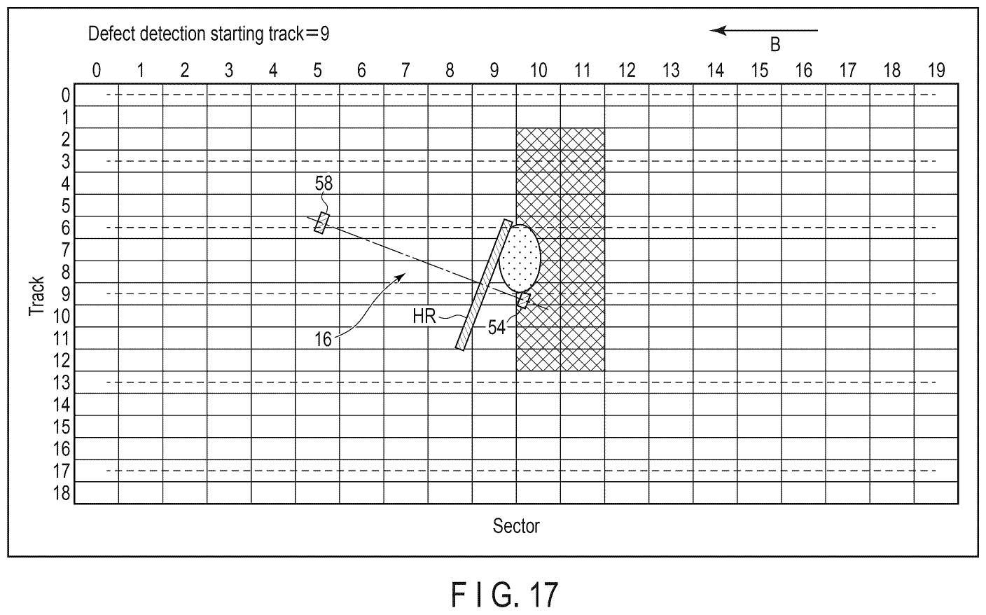

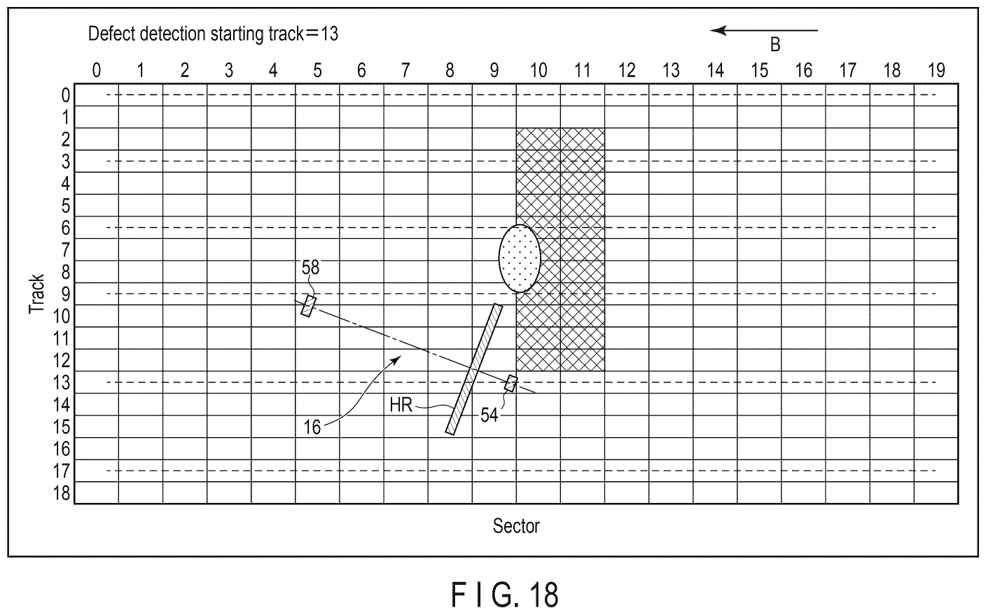

FIG. 16, FIG. 17, and FIG. 18 are plan views of the HDD of the present embodiment showing the operation of detecting defects (projections or recesses) on the surface of the magnetic disk 12 and the operation of setting record-prohibited tracks or record-prohibited sectors, respectively.

According to the present embodiment, in order to reduce the defect inspection time, the thermal resistance sensor HR does not inspect defects for each recording track, but inspects a plurality of recording tracks covered by the width W3 of the thermal resistance sensor HR simultaneously as one bundle, as shown in FIG. 16. In the example shown in the drawing, the width W3 of the thermal resistance sensor HR is set to be approximately seven tracks wide. The thermal resistance sensor HR simultaneously inspects +/−3 tracks around the positioned recording track.

In one example, the thermal resistance sensor HR starts inspecting from recording tracks 0 to 6 on the outermost circumference and moves in a radial direction (in the direction of the width of the recording tracks) by a predetermined feed pitch (feed width), for example, by a plurality of tracks, every time the magnetic disk 12 rotates at least one round, and inspects the next bundle of recording tracks. The inspection circuit 46d of the controller 40 detects the presence or absence of surface defects and the location of surface defects (in this case, surface projections) based on the sensor output of the thermal resistance sensor HR, and further determines whether the defects are projections or recesses. When a projection is detected, the controller 40 determines that a projection is present in the shaded areas in FIG. 16 (e.g., tracks 2 to 9, sectors 10 and 11) and registers the above areas in the memory 47.

Next, as shown in FIG. 17, the controller 40 moves the magnetic head 16 inward in the radial direction (track width direction) by a predetermined feed pitch (e.g., three tracks equivalent to half the track conversion width of the thermal resistance sensor HR), and performs defect detection for recording tracks 6 to 11 using the thermal resistance sensor HR.

Note that the controller 40 sets the feed pitch of the magnetic head 16 at the time of defect inspection in advance and stores the set value in the memory 47. It is desirable that the feed pitch (feed width) of the magnetic head is set within ½ of the third width W3 of the thermal resistance sensor HR and at least for three recording tracks. In the present embodiment, as an example, the feed pitch is set to a track width of three tracks.

Next, as shown in FIG. 18, the controller 40 repeats the operation of moving the magnetic head 16 in the radial direction by three tracks for each rotation of the magnetic disk 12 to identify recording tracks where surface projections may be present. After the inspection of all recording tracks is completed, the controller 40 sets the recording tracks where the detected surface projections may be present as record-prohibited tracks and registers the set record-prohibited tracks in the memory 47. Note that the record-prohibited tracks can be further set by considering the relative positions of the write head 58, the read head 54, and the thermal resistance sensor HR.

In a normal recording operation, the controller 40 prohibits information recording on the registered record-prohibited tracks, i.e., prohibits access of the magnetic head 16 to the record-prohibited tracks. This avoids the magnetic head 16 from colliding with the surface projections of the magnetic disk 12.

According to the HDD of the present embodiment described above, for example, in a case where the total number of tracks is 600,000 and the rotation speed of the recording medium is 7200 rpm, if a thermal resistance sensor of 1 μm width is used to simultaneously inspect a number of recording tracks equivalent to 70% of that width for defects, all recording tracks can be inspected in about 12 minutes. In contrast, in the case of inspecting for defects one track at a time using a conventional method, assuming that it takes one lap for inspection and one lap for track movement, it will take approximately 160 minutes to inspect all recording tracks on one side of the recording medium for defects.

As described above, according to the HDD of the present embodiment, the defect inspection time of the magnetic disk surface can be significantly reduced, and it is possible to inspect defects and set record-prohibited tracks in a short time. As a result, according to the present embodiment, damage to the magnetic head due to defects on the recording medium can be prevented, and a magnetic disk device with improved reliability can be provided.

Next, HDDs according to other embodiments will be described. In the other embodiments described below, portions identical to the first embodiment described above will be denoted the same reference symbols to omit or simplify detailed descriptions thereof. The description will focus on portions that differ from the first embodiment.

### Second Embodiment

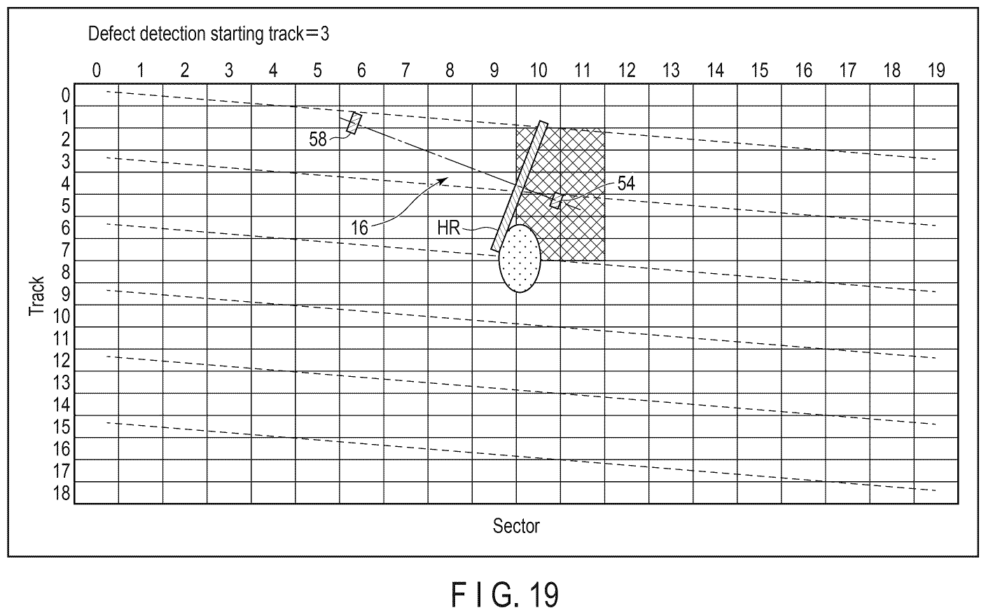

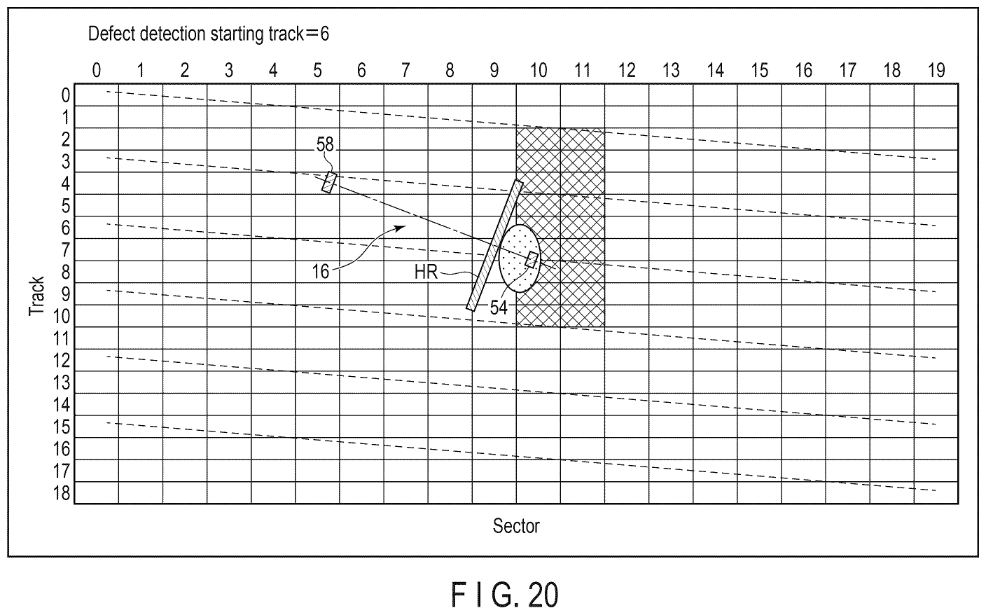

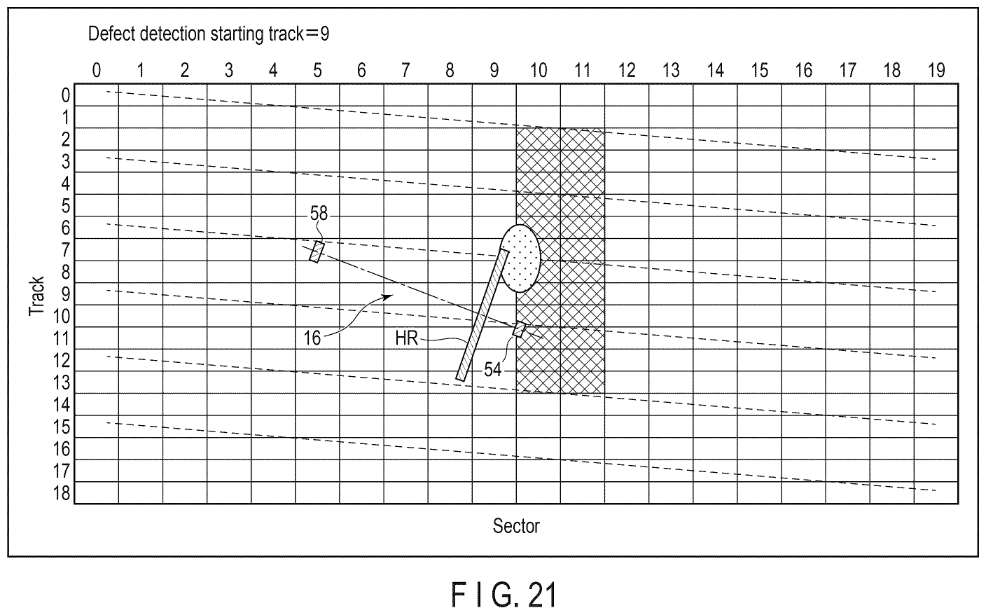

FIG. 19, FIG. 20, and FIG. 21 are plan views respectively showing an operation of detecting defects (projections or recesses) on a surface of a magnetic disk 12 and an operation of setting record-prohibited tracks or record-prohibited sectors in an HDD according to a second embodiment.

In the first embodiment described above, a magnetic head is moved in a track width direction by a predetermined feed pitch (by three tracks) every time a magnetic disk makes one lap when inspecting defects on the surface of a magnetic disk. That is, in the first embodiment, it takes one lap for the defect inspection and one lap for the track movement of the magnetic head.

In contrast, according to the HDD of the second embodiment, as shown in FIG. 19, FIG. 20, and FIG. 21, when inspecting a defect on the surface of a magnetic disk, a controller 40 performs defect inspection of a recording track while continuously moving a magnetic head 16 in a radial direction (track width direction) by a predetermined feed pitch, for example, three tracks, while a magnetic disk 12 makes one lap. In other words, the controller 40 performs defect inspection while moving the magnetic head 16 in a spiral manner relative to the surface of the magnetic disk 12, as shown by the dashed line in the drawing. That is, according to the second embodiment, the defect inspection and the radial movement of the magnetic head are carried out simultaneously.

According to the second embodiment configured as described above, the time for inter-track movement of the magnetic head can be reduced by moving the magnetic head in a spiral manner. According to the second embodiment, the inspection time in the first embodiment described above can be further reduced, and defect inspection can be performed in approximately six minutes.

For example, in the case of an HDD with 10 magnetic disks (recording media), there are 20 recording media surfaces to be inspected for defects. While conventional HDDs require 3200 minutes for defect inspection, the HDD according to the second embodiment makes it possible to reduce the inspection time to 120 minutes.

According to the HDD of the second embodiment, the defect inspection time of the magnetic disk surface can be further reduced, and it is possible to inspect defects and set record-prohibited tracks in a shorter time. As a result, according to the present embodiment, damage to the magnetic head due to defects on the recording medium can be prevented, and a disk device with improved reliability can be provided.

The arrangement relationship of the read head 54, the write head 58, and the thermal resistance sensor HR in the magnetic head 16 is not limited to the first embodiment described above and can be changed in various ways.

### (First Modification)

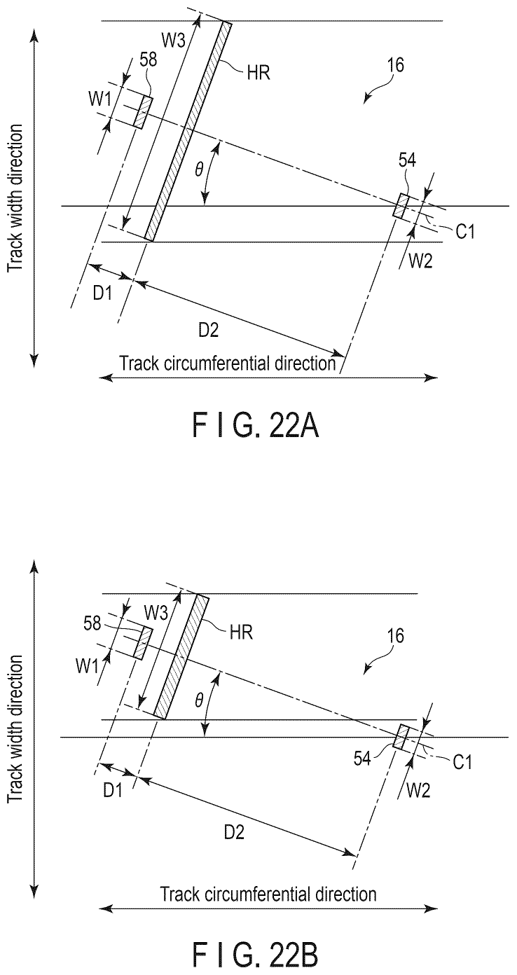

FIG. 22A shows a positional relationship between a thermal resistance sensor and an element part of a magnetic head according to a first modification. As shown in the drawing, according to the first modification, a thermal resistance sensor HR of a magnetic head 16 is arranged to be located closer to a write head 58 side. That is, a spacing D1 between the write head 58 and the thermal resistance sensor HR and a spacing D2 between a read head 54 and the thermal resistance sensor HR in a direction parallel to a central axis C1 are set to D1<D2.

In a case where a recording track width is 0.05 μm, a width W3 of the thermal resistance sensor HR is set to be sufficiently wide, approximately 1 μm. That is, the width W3 of the thermal resistance sensor HR is sufficiently wider than a width W1 of the distal end portion of the write head 58, and is set to be several times wider than the width W1, for example, approximately 20 times wider.

### (Second Modification)

FIG. 22B shows a positional relationship between a thermal resistance sensor and an element part of a magnetic head according to a second modification. As shown in the drawing, according to the second modification, a thermal resistance sensor HR of a magnetic head 16 is arranged to be located closer to a write head 58 side. That is, a spacing D1 between the write head 58 and the thermal resistance sensor HR and a spacing D2 between a read head 54 and the thermal resistance sensor HR in a direction parallel to a central axis C1 are set to D1<D2.

In a case where a recording track width is 0.05 μm, a width W3 of the thermal resistance sensor HR is set to a narrow width of approximately 0.5 μm. That is, the width W3 of the thermal resistance sensor HR is wider than a width W1 of the distal end portion of the write head 58, and is set to be several times wider than the width W1, for example, approximately 10 times wider.

### (Third Modification)

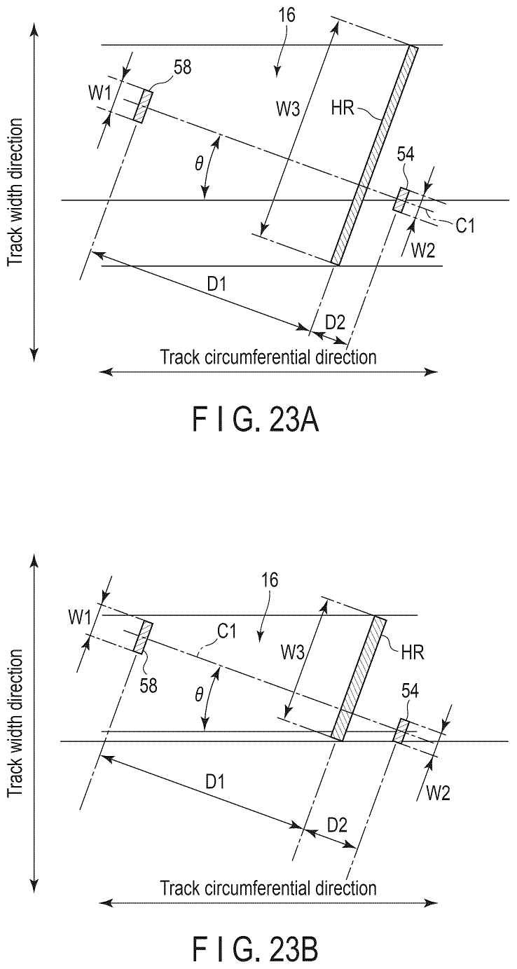

FIG. 23A shows a positional relationship between a thermal resistance sensor and an element part of a magnetic head according to a third modification. As shown in the drawing, according to the third modification, a spacing D1 between a write head 58 and a thermal resistance sensor HR and a spacing D2 between a read head 54 and the thermal resistance sensor HR in a direction parallel to a central axis C1 are set to D1>D2. The thermal resistance sensor HR is arranged to be located with its center in the width direction away (displaced) from the central axis C1 in the width direction perpendicular to the central axis.

In a case where a recording track width is 0.05 μm, a width W3 of the thermal resistance sensor HR is set to a wide width of approximately 1 μm. That is, the width W3 of the thermal resistance sensor HR is wider than a width W1 of the distal end portion of the write head 58, and is set to be several times wider than the width W1, for example, approximately 20 times wider.

The write head 58 and the read head 54 are located overlapping the thermal resistance sensor HR in a track circumferential direction.

### (Fourth Modification)

FIG. 23B shows a positional relationship between a thermal resistance sensor and an element part of a magnetic head according to a fourth modification. As shown in the drawing, according to the fourth modification, a spacing D1 between a write head 58 and a thermal resistance sensor HR and a spacing D2 between a read head 54 and the thermal resistance sensor HR in a direction parallel to a central axis C1 are set to D1>D2. The thermal resistance sensor HR is arranged to be located with its center in the width direction deviated from the central axis C1 in the width direction.

In a case where a recording track width is 0.05 μm, a width W3 of the thermal resistance sensor HR is set to a narrow width of approximately 0.5 μm. That is, the width W3 of the thermal resistance sensor HR is wider than a width W1 of the distal end portion of the write head 58, and is set several times wider than the width W1, for example, approximately 10 times wider.

The write head 58 and the read head 54 are located overlapping the thermal resistance sensor HR in a track circumferential direction.

The same effects as in the first embodiment described above can be obtained even in the case of using any of the magnetic heads of the first or fourth modifications configured as described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the feed pitch of the magnetic head during defect inspection is not limited to three tracks, but can be changed within a range of ½ of the third width W3 and equal to or greater than three recording tracks. By increasing the feed pitch, the defect inspection time can be further shortened.

The material, shape, size, etc. of the elements configuring the head portion of the magnetic head can be changed as needed. In the magnetic disk device, the number of magnetic disks and magnetic heads can be increased or decreased as needed, and the size of magnetic disks can be selected in various ways.

What is claimed is:

1. A magnetic disk device comprising:
a rotatable disk-shaped recording medium including a plurality of concentric recording tracks;
a magnetic head comprising a recording element having a first width in a direction intersecting the recording tracks, a reproducing element having a second width in a direction intersecting the recording tracks, and a thermal resistance sensor having a third width in a direction intersecting the recording tracks, which is wider than the first width and the second width, and detecting a surface condition of the recording medium;
a head actuator that positions the magnetic head on any recording track of the recording medium;
a detection circuit that detects defects on a surface of the recording medium based on a sensor output of the thermal resistance sensor; and
a controller that, when inspecting the surface condition of the recording medium by the thermal resistance sensor, sets a feed pitch of the magnetic head in a width direction of the recording track to within ½ of the third width of the thermal resistance sensor and three or more recording tracks.

2. The magnetic disk device of claim 1, wherein
when inspecting the surface condition of the recording medium, the controller drives the head actuator so that the magnetic head is moved within ½ of the third width of the thermal resistance sensor and three or more recording tracks in the feed pitch direction for every rotation of the recording medium.

3. The magnetic disk device of claim 1, wherein
when inspecting the surface condition of the recording medium, the controller drives the head actuator so that the magnetic head is continuously moved within ½ of the third width of the thermal resistance sensor and three or more tracks in the feed pitch direction during one rotation of the recording medium.

4. The magnetic disk device of claim 1, wherein the recording element and the reproducing element are arranged side by side at intervals in a first direction intersecting the recording tracks, and the thermal resistance sensor is arranged side by side with the recording element and the reproducing element in the first direction and is located between the recording element and the reproducing element.

5. The magnetic disk device of claim 4, wherein the recording element, the reproducing element, and the thermal resistance sensor each have their centers in the width direction located on a central axis extending in the first direction.

6. The magnetic disk device of claim 4, wherein
the recording element and the reproducing element each have their centers in the width direction located on the central axis extending in the first direction, and
the thermal resistance sensor has its center in the width direction spaced apart from the central axis in a direction perpendicular to the central axis.

7. The magnetic disk device of claim 1, wherein the magnetic head comprises a thermal actuator.
